(19) United States
(12) Patent Application Publication
(10) Pub. No.: US 2018/0005112 A1
(43) Pub. Date: Jan. 4, 2018

(54) ARTIFICIAL NEURAL NETWORK WITH SIDE INPUT FOR LANGUAGE MODELLING AND PREDICTION

(71) Applicant: Microsoft Technology Licensing, LLC, Redmond, WA (US)

(72) Inventors: Juha ISO-SIPILA, London (GB); Matthew James WILLSON, London (GB)

(21) Appl. No.: 15/245,934

(22) Filed: Aug. 24, 2016

(30) Foreign Application Priority Data
Jun. 30, 2016 (GB) 1611380.5

(51) Int. Cl. G06N 3/08; G06N 3/04

(52) U.S. Cl. CPC G06N 3/08; G06N 3/04

(57) ABSTRACT

The present invention relates to an improved artificial neural network for predicting one or more next items in a sequence of items based on an input sequence item. The artificial neural network is implemented on an electronic device comprising a processor, and at least one input interface configured to receive one or more input sequence items, wherein the processor is configured to implement the artificial neural network and generate one or more predicted next items in a sequence of items using the artificial neural network by providing an input sequence item received at the at least one input interface and a side input as inputs to the artificial neural network, wherein the side input is configured to maintain a record of input sequence items received at the input interface.

### CROSS-REFERENCE TO RELATED APPLICATION

This non-provisional utility application claims priority from United Kingdom patent application serial number 1611380.5 entitled “Artificial Neural Network With Side Input for Language Modelling and Prediction” and filed on Jun. 30, 2016, which is incorporated herein in its entirety by reference.

### BACKGROUND

Modern mobile electronic devices, such as mobile phones and tablets, typically receive typed user input via soft keyboards, which include a variety of additional functionality beyond simply receiving keyboard input. One of these additional functions is the ability to predict the next word that a user will input via the keyboard given the previous word or words that were input. This prediction is typically generated using an n-gram based predictive language model, such as that described in detail in European Patent number 2414915.

One of the often criticised drawbacks of n-gram based predictive language models is that they rely on statistical dependence of only a few previous words. By contrast, artificial neural networks, and recurrent neural network language models in particular, have been shown in the art to perform better than n-gram models at language prediction (Recurrent Neural Network Based Language Model, Mikolov et al, 2010; RNNLM—Recurrent Neural Network Language Modeling Toolkit, Mikolov et al, 2011).

An artificial neural network is a statistical learning algorithm, the architecture of which is derived from the networks of neurons and synapses found in the central nervous systems of animals. Artificial neural networks are effective tools for approximating unknown functions that depend on a large number of inputs. However, in this context ‘function’ should be given its widest possible meaning as ‘any operation that maps inputs to outputs’. Artificial neural networks are not only useful for approximating mathematical functions but also find wide use as classifiers, in data processing and robotics, among others.

In order to approximate these unknown functions, artificial neural networks are trained on large datasets of known inputs and associated known outputs. The known inputs are input to the artificial neural network and the values of various internal properties of the artificial neural network are iteratively adjusted until the artificial neural network outputs or approximates the known output for the known input. By carrying out this training process using large datasets with many sets of known inputs and outputs, the artificial neural network is trained to approximate the underlying function that maps the known inputs to the known outputs. Often, artificial neural networks that are used to approximate very different functions have the same general architecture of artificial neurons and synapses; it is the training process that provides the desired behaviour.

When using a language model to perform language prediction, it is often desirable to take the context of the language model, e.g. previous states of the language model, into account. Existing solutions which make use of context, such as the Recurrent Neural Network Language Model described by Mikolov et al, are limited to a short-term context which relates to the current sentence or paragraph when making predictions.

There is, therefore, a need for an artificial neural network predictive language model that is able to take into account longer-term context when making language predictions.

### SUMMARY

In a first aspect of the invention, an electronic device is provided, the electronic device comprising a processor, and at least one input interface configured to receive one or more input sequence items. The processor is configured to implement an artificial neural network and generate one or more predicted next items in a sequence of items using the artificial neural network by providing an input sequence item received at the at least one input interface and a side input as inputs to the artificial neural network, wherein the side input is configured to maintain a record of input sequence items received at the input interface.

The processor of the electronic device may be configured to generate the one or more predicted next items in the sequence of items by providing the input sequence item and the side input as inputs to an input layer of the artificial neural network.

The processor may be configured to generate one or more subsequent predicted items in the sequence. The one or more subsequent predicted items may be generated by providing a second input sequence item and the side input as inputs to an input layer of the artificial neural network. The second input sequence item may be the previously predicted next item in the sequence output by the artificial neural network.

In some embodiments of the invention, the artificial neural network may be a fixed context neural network.

In the first embodiment, the processor may be configured to generate the one or more predicted next items in a sequence of items by further providing one or more additional input sequence items as input to the artificial neural network. The input sequence item and one or more additional sequence items may be consecutive previous sequence items. In this way, short-term historical context may be provided to the artificial neural network, improving the accuracy of the output predicted next items in the sequence.

The input sequence items and the side input may be concatenated to form an input vector that is provided to an input layer of the artificial neural network.

In some embodiments of the invention, the artificial neural network may be a recurrent neural network. The processor may be configured to generate one or more predicted next items in the sequence of items by, first, processing the side input with the artificial neural network by providing the side input to an input layer of the artificial neural network to initialise the artificial neural network and, subsequently, processing the input sequence item with the artificial neural network by providing the input sequence item to the input layer of the artificial neural network to generate the one or predicted next items in the sequence of items.

The processor may be configured to generate one or more subsequent predicted items in the sequence by providing a second input sequence item as an input to an input layer of the artificial neural network. The second input sequence item may be the previously predicted next item in the sequence output by the artificial neural network.

In a second aspect of the invention, an electronic device is provided, the electronic device comprising a processor, and at least one input interface configured to receive one or more input sequence items. The processor is configured to implement an artificial neural network,

estimate an initial state of the artificial neural network based on a side input, wherein the side input is configured to maintain a record of input sequence items received at the input interface, and generate one or more predicted next items in a sequence of items using the artificial neural network by providing an input sequence item received at the at least one input interface as input to the artificial neural network.

The artificial neural network may be a recurrent neural network, and the processor may estimate an initial state of the artificial neural network by estimating values for a recurrent hidden vector of the recurrent neural network and/or estimating the weightings between the layers on the artificial neural network.

The artificial neural network may further comprise a side input layer, and the processor may be configured to estimate the initial state of the artificial neural network based on a side input by providing the side input to the side input layer.

The side input layer may include a side input weight matrix, and wherein the processor is configured to multiply the side input with the side input weight matrix to estimate the values of the initial state of the recurrent hidden vector. The nodes of the side input layer may further comprise a non-linearity.

The processor may be configured to generate the one or more predicted next items in a sequence by providing the side input as a further input to the input layer of the artificial neural network.

The processor may be further configured to generate one or more subsequent predicted items in the sequence by providing a second input sequence item as an input to an input layer of the artificial neural network. The second input sequence item may be the previously predicted next item in the sequence output by the artificial neural network.

In any of the aspects or embodiments of the invention, the side input may be a side input vector. The side input vector may maintain a frequency count for each item that appears in the sequence of items. Alternatively or additionally, the side input vector may maintain a frequency count for groups of items that appear in the sequence of items.

The side input vector may also include elements indicative of a context of the electronic device. The context of the electronic device may include one or more of: a current application running on the electronic device, a recipient of a message that is typed, time or day, location

The processor may be configured to multiply the side input vector with an encoding matrix before it is input to the artificial neural network.

The sequence of items may be a sequence of one of more of: words, characters, morphemes, word segments, punctuation, emoticons, emoji, stickers, and hashtags.

The at least one input interface may be a keyboard, and the input sequence item may be one of: a word, character, morpheme, word segment, punctuation, emoticon, emoji, sticker, a hashtag, and keypress location on a soft keyboard.

The electronic device may further comprise a touch-sensitive display, the keyboard may be a soft keyboard and the processor may be configured to output the soft keyboard on a display.

The processor may be further configured to generate one or more display objects corresponding to the generated one or more predicted next items in a sequence of items and output the one or more display objects on a display.

The one or more display objects may be selectable, and upon selection of one of the one or more display objects, the processor may be configured to select the sequence item corresponding to the selected display object. The processor may be configured to generate one or more subsequent predicted items in the sequence of items based on the selected one of the one or more selectable display objects.

The processor may be configured to update the side input according to the generated predicted sequence items. Alternatively, or additionally, the processor may be configured to update the side input according to the selected sequence item.

The processor may be configured to store generated or selected predicted sequence items and update the side input with the stored sequence items periodically. The side input may also be updated using data retrieved from one or more external user-specific data sources, such as one or more of: an email account or a social media account.

The electronic device may be configured to store a plurality of alternative side inputs, and the electronic device may be configured to choose the side input used by the electronic device, to generate one or more predicted next items in a sequence of items, from the stored plurality of alternative side inputs based on one or more of: an operating status of the electronic device, an application running on the electronic device, a context of the electronic device.

### BRIEF DESCRIPTION OF THE DRAWINGS

FIG. 1 depicts an example feedforward artificial neural network according to the prior art.

FIG. 2 depicts an example unit of a layer of an artificial neural network according to the prior art.

FIG. 3 depicts a prior art recurrent neural network used for predictive language modelling.

FIG. 4 is a diagram depicting short- and long-term contexts and a side input according to the present invention.

FIG. 5 is a diagram demonstrating how side inputs representing long-term context and short-term context is provided to a Fixed Context Neural Network.

FIG. 6 depicts a recurrent neural network with a side input for initialising the state of the recurrent neural network.

FIG. 7 is a schematic diagram of an electronic device incorporating an artificial neural network as described herein.

### DETAILED DESCRIPTION

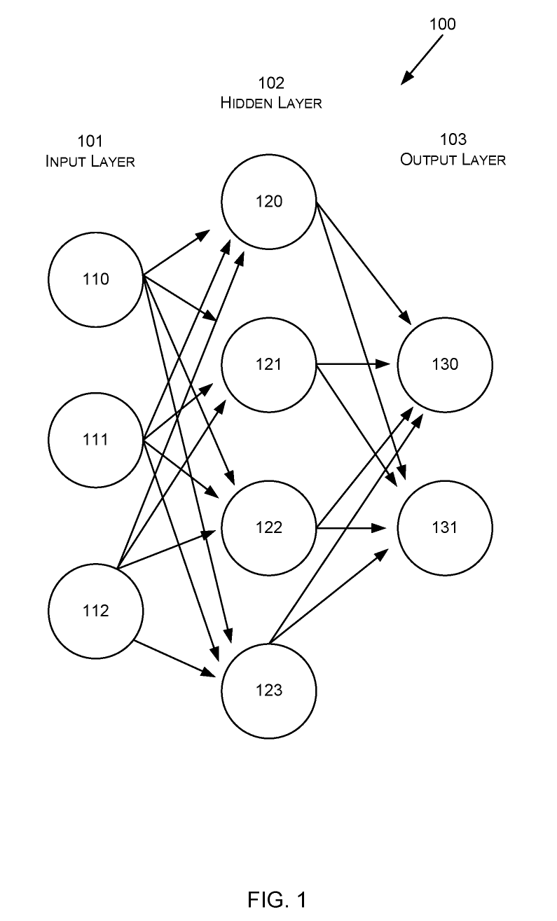

FIG. 1 depicts a simple artificial neural network 100 according to the state of the art. Essentially, an artificial neural network, such as artificial neural network 100, is a chain of mathematical functions organised in directionally dependent layers, such as input layer 101, hidden layer 102, and output layer 103, each layer comprising a number of units or nodes, 110-131. Artificial neural network 100 is known as a ‘feedforward neural network’, since the output of each layer 101-103 is used as the input to the next layer (or, in the case of the output layer 103, is the output of the artificial neural network 100) and there are no backward steps or loops. It will be appreciated that the number of units 110-131 depicted in FIG. 1 is exemplary and that a typical artificial neural network includes many more units in each layer 101-103.

In the operation of the artificial neural network 100, input is provided at the input layer 101. This typically involves mapping the real-world input into a discrete form that is suitable for the input layer 101 i.e. that can be input to each of the units 110-112 of the input layer 101. For example, artificial neural networks such as artificial neural network 100 can be used for optical character recognition (OCR). Each unit 110-112 of the input layer may correspond to a colour channel value for each pixel in a bitmap containing the character to be recognised.

After input has been provided to the input layer 101, the values propagate through the artificial neural network 100 to the output layer 103. Each of the units of the hidden layer 102—so called because its input and output is contained within the neural network—is essentially a function that takes multiple input values as parameters and returns a single value. Taking unit 120 of hidden layer 102, for example, the unit 120 receives input from units 110, 111 and 112 of the input layer 101 and produces a single output value that is then passed to units 130 and 131 of the output layer 103.

The units 130 and 131 of the output layer 103 operate in a similar manner to those of the hidden layer 102. Each unit 130 and 131 of the output layer 103 receives input from all four units 120-123 of the hidden layer 102, and outputs a single value. The outputs of the output layer, like the inputs to the input layer are discrete values that are somehow mapped to real-world quantities. In the OCR example, the output layer 103 may have a unit corresponding to each character that the artificial neural network 100 is capable of recognising. The recognised character can then be indicated in the output layer 103 by a single unit with a value of 1, while the remaining units have a value of zero. In reality, the artificial neural network 100 is unlikely to provide an output as clean as this, and the output layer 103 will instead have multiple units with various values, each indicating a probability that the input character is the character associated with that unit.

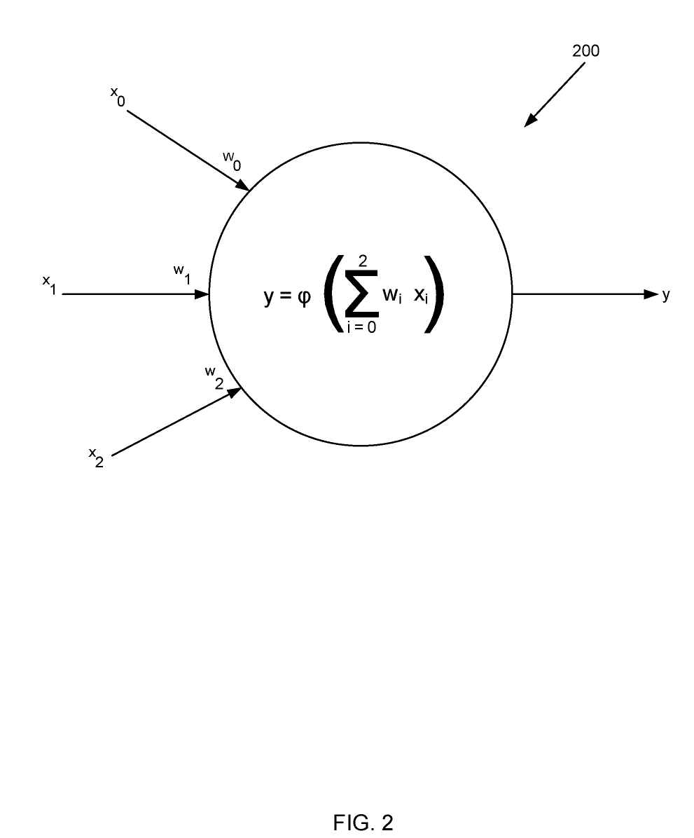

The operation and configuration of the units 120-131 of the hidden layer 102 and output layer 103 is now described in more detail with respect to FIG. 2. The unit 200 of FIG. 2 may be one of the units 120-131 of the artificial neural network 100 described above. The unit 200 receives three inputs x0, x1 and x2 from units in the preceding layer of the artificial neural network. As these inputs are received by the unit 200, they are multiplied by corresponding adaptive weight values w0, w1 and w2. These weight values are ‘adaptive’ because these are the values of the artificial neural network that are modified during the training process. It will be appreciated that the values x0, x1 and x2 are generated by the units of the preceding layer of the neural network and are, therefore, dependent on the input to the neural network. The adaptive weight values w0, w1 and w2 are independent of the input, and are essential for defining the behaviour of the artificial neural network.

After the inputs x0, x1 and x2 are multiplied by the adaptive weight values, their products are summed and used as input to a transfer function φ. The transfer function φ is often a threshold function such as a step function, which is analogous to a biological neuron in that it ‘fires’ when its input reaches a threshold. Other transfer functions may be and are often used, such as the sigmoid activation function, the softmax function, and linear combinations of the inputs. The output of the transfer function φ is the output of the unit 200.

As mentioned above, the artificial neural network 100 is trained using large sets of data with known inputs and known outputs. For example, if the artificial neural network 100 is to be used to predict the next word in a sentence, taking the current word as input, the artificial neural network 100 can be trained using any suitable body of text. A common algorithm that is used to train artificial neural networks is the backward propagation of errors method, often referred to as simply backpropagation. Backpropagation works by adjusting the adaptive weights, for example w0, w1 and w2 of FIG. 2, to minimise the error or discrepancy of the predicted output against the real output. A detailed description of the backpropagation algorithm can be found at Chapter 7 of Neural Networks—A Systematic Introduction by Raul Rojas, published by Springer Science & Business Media, 1996.

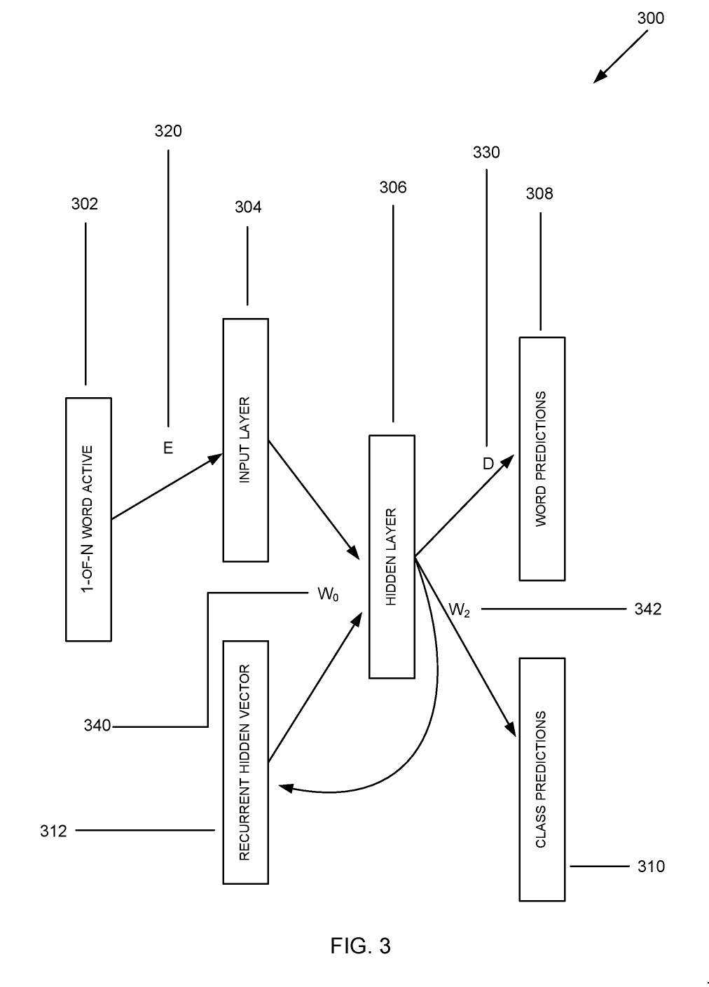

FIG. 3 depicts an artificial neural network 300 as described by Mikolov et al. in “RNNLM—Recurrent Neural Network Language Modeling Toolkit”, 2010. The artificial neural network 300 is used to predict the next word in textual data given a context, taking a current word as its input and producing a predicted next word as its output.

Like the artificial neural network 100, the artificial neural network 300 comprises an input layer 304, a hidden layer 306, and an output layer, which in this case provides word predictions 308. As with a typical artificial neural network, the artificial neural network 300 comprises adaptive weights in the form of a first weight matrix 340 that modifies the values of the units of the input layer 304 as they are passed to the hidden layer 306. The artificial neural network 300 also includes an encoding matrix 320 and a decoding matrix 330. The encoding matrix 320 maps the real-world words into a discrete form that can be processed by the units of the artificial neural network 300. The decoding matrix 330 modifies the values of the units of the hidden layer 106 as they are passed to the output layer 108 to turn the result of the artificial neural network 300's processing into a real-world word.

Words input to the artificial neural network 300 are represented in 1-of-N form 302, i.e. a series of N bits, all having a value of 0 except for a single bit having a value of 1. The N different 1-of-N vectors, each with a unique position of the 1 bit, map to words in a predefined vocabulary. The 1-of-N representation 302 is modified by the encoding matrix 320 to provide the values of the input layer 304.

In addition to the input, hidden and output layers of a typical feedforward artificial neural network, the artificial neural network 300 also comprises a recurrent hidden vector (recurrent hidden vector) 312. With each pass of the artificial neural network 300, before the values of the units of the input layer 304 are modified by the weight matrix 340, the values of the units of the recurrent hidden vector 312 are concatenated with the values of the units of the input layer 304. The term ‘concatenated’ as used here has the standard meaning in the art: the values of the units of recurrent hidden vector 312 are appended to the values of the units of the input layer 304, or vice versa. The concatenated values of the units of the input layer 304 and recurrent hidden vector 312 are then multiplied by the first weight matrix 340 and passed to the hidden layer 306. Following each pass of the artificial neural network 300, the values of the units of the hidden layer 306 are copied to the recurrent hidden vector 312, replacing the previous recurrent hidden vector. By introducing the recurrent hidden vector 312, the artificial neural network 300 is able to maintain the short-term context of previously predicted words between predictions, improving the accuracy of the system when used in an inherently context-based application such as language modelling.

When the softmax activation function is used in the output layer, the values of the units of the output layer represent the probability distribution of the next word given the input word and, via the recurrent hidden vector 312, the state of the hidden layer at the previous pass.

The artificial neural network 300 may also comprise a class prediction output 310. By multiplying the values of the units of the hidden layer 306 by a second weight matrix 342, a word class prediction is provided, where the classes are logical groupings of possible output words.

Alternative neural network language models, such as a Fixed Context Neural Network (FCNN) do not use a recurrent hidden vector to maintain the context of previous predicted words between predictions, but instead rely on additional inputs to provide short-term context, such as previously predicted words, as an input to the neural network. The output of a fixed context neural network may operate in the same way as described above for a recurrent hidden vector by providing word predictions and/or class outputs

The present invention provides a new framework for an artificial neural network predictive language model that is able to maintain a long-term context via a summary of a user's historical language use. This long-term context is used as an additional, or “side”, input into the artificial neural network, either by providing both the input word and side input as inputs to the artificial neural network, using the side input to initialise the recurrent hidden vector of a recurrent neural network, or using the side input to estimate an initial state of the artificial neural network.

In a preferred embodiment, the side input is a cumulative unigram count that maintains a record of the number of times a user has used one or more particular unigrams. The unigrams that are part of the side input may comprise one or more of words, characters, morphemes, word segments, punctuation, emoticons, emoji, stickers, and hashtags, etc.

The side input is preferably provided as a side input vector, in which the individual elements of the vector relate to parameters of the long-term context. Furthermore, it is not necessary that all of the elements of the side input vector correspond to the same type of data. For example, some of the elements may correspond to unigram counts, other elements may correspond to groups or classes of unigrams, and other elements may be indicative of a context of the electronic device.

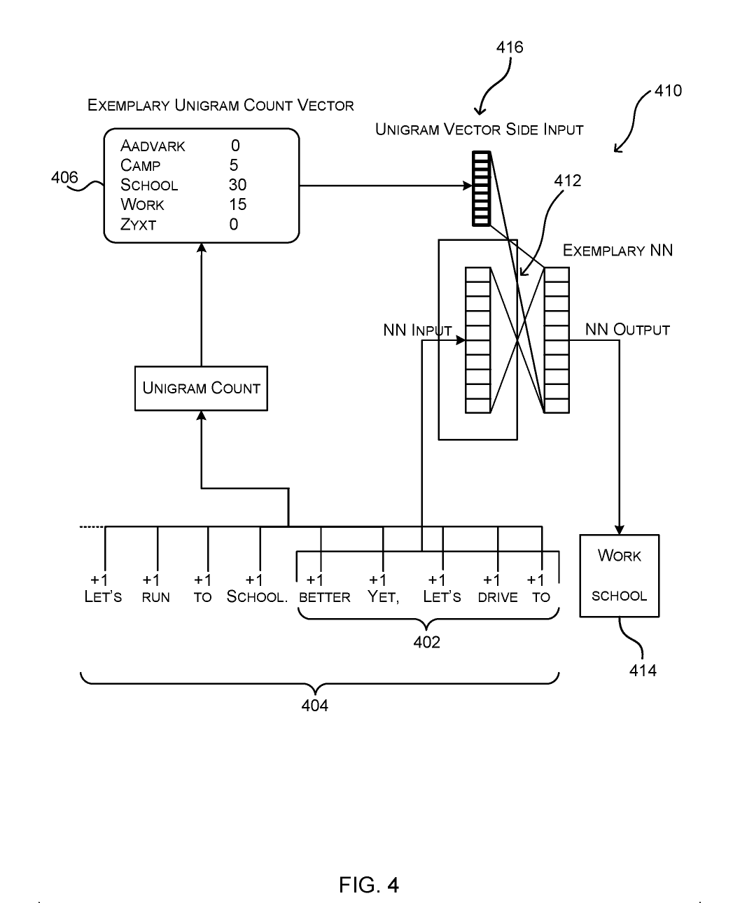

Existing solutions that employ neural network language models, such as the fixed context neural network, use context from the current sentence or paragraph as an additional input to the artificial neural network, alongside the current input word. This short-term context is depicted in FIG. 4 in which the individual unigrams of the current sentence 402, “Better”, “yet,”, “let's”, “drive”, and “to”, are depicted as an input to the input layer 412 of the neural network 410. The longer-term context 404 is depicted as comprising the unigrams of the current sentence 402 and the unigrams of a previous sentence “Let's run to school.”; however, it will be appreciated that the longer-term context may comprise significantly more information, for example every word input in the current paragraph, current section, current text-input session, a lifetime history of all recorded input words, and/or inputs from other sources such as social media, email accounts, etc.

The side input 406, e.g. a unigram count vector, can be presented as an additional or side input 416 into the input layer of the neural network 410, along with the unigrams of the current sentence 402, allowing long term context of the user's typing to influence the output.

Also depicted is the neural network output 414. The output of the neural network may be used to find the single most-likely next word in the sentence, e.g. “school”, or may be used to provide multiple suggestions of the next word in the sentence, e.g. “camp”, “work” and “school”. The side input 416 provides a long-term context beyond that provided by the current sentence, allowing the system to present predictions using unigram prior history as additional context. For example, if a user commonly texts about school but rarely about camp, which may both be predictions based on the sentence context, the user's prior usage of the unigram “school” will make it a more likely prediction in the output 414. Of course, this is a simplified example of the way in which context works in a neural network language model. The use of an artificial neural network allows trained similarities and associations between different words to be used in making predictions, unlike n-gram models.

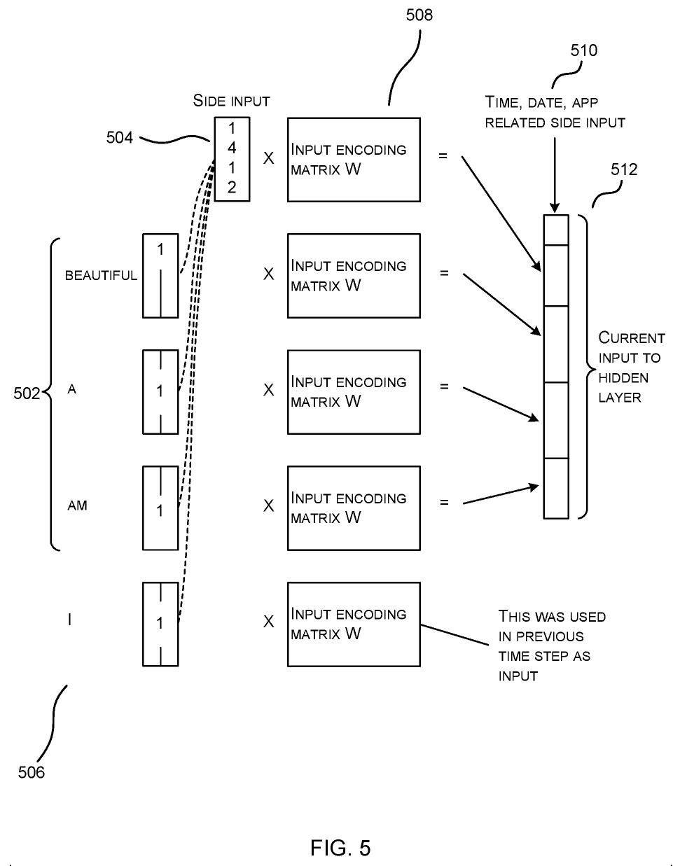

FIG. 5 depicts a method of providing the side input as an input to the input layer of a Fixed Context Neural Network (fixed context neural network), i.e. a neural network that does not internally maintain any record of context beyond the context that is inherent as a result of the training of the neural network. There are 5 elements of the current input to the hidden layer depicted: three previous unigrams “am”, “a” and “beautiful” 502, the side input 504 (e.g. a unigram count vector), and other related side inputs 510 (e.g. time, date, app-related data). Also shown is a previous unigram “I” 506, which is not provided as input to the neural network since only the three most-recent unigrams are provided in the present example. It will be appreciated that other numbers of previous unigrams could be used, for example a fixed number of previous unigrams, all previous unigrams in the current sentence or paragraph, or number of previous unigrams up to a maximum number, etc.

As depicted in FIG. 5, each of the elements of the input 512 may be concatenated into a single vector that is provided as an input to the neural network. Each of the unigram inputs 502 may be a one-hot or 1-of-N vector which has a zero in every element except the element corresponding to the unigram. The side input 504 may be a unigram count vector as described above, and may also include additional context information as described herein, such as a context of the electronic device. Both the unigram inputs 502 and the side input 504 are multiplied by an encoding matrix 508 to provide the input to neural network 512. Since the encoding matrix encodes the relationship between the 1-of-N vectors (and the unigram count vector) and the neural network, it is not applied to the other related side input 510 since it does not relate to unigrams. The input is then processed by the artificial neural network to generate one or more predictions for the next word in the sentence.

While the use of the side input as an additional input to the neural network has been described above with respect to a fixed context neural network, it will be appreciated that the arrangement depicted in FIG. 5 can also be applied to other types of neural network language models. For example, when applied to a recurrent neural network, only one previous unigram 502 would be provided as an input to the neural network, along with the side input 504 and, possibly, other side input 510.

When the side input is used with a recurrent neural network, the side input may be provided to the uninitialized recurrent neural network (i.e. the values of the elements of the recurrent hidden vector are uninitialized) as an input before the current word, e.g. at the start of each typing session. By processing the side input with the artificial neural network prior to processing any input sequence items, the values of the elements of the recurrent hidden vector are initialised based on the long-term context provided by the side input. The recurrent hidden vector, when initialised in this way, reflects the long-term context and is subsequently updated according to subsequent inputs to the recurrent neural network.

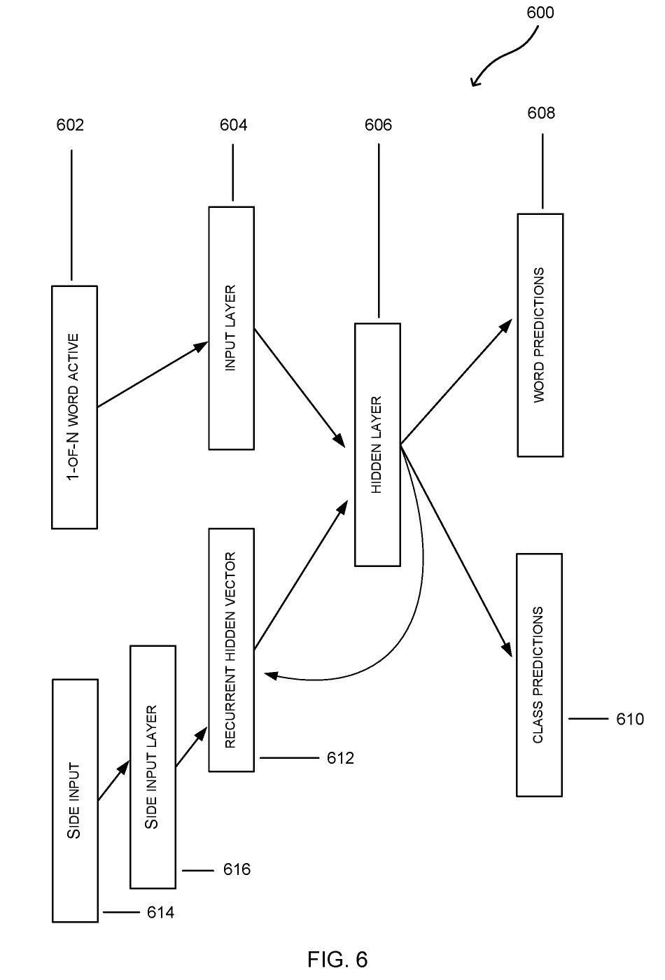

Alternatively, the side input may be used to estimate directly the initial state of the recurrent neural network. Specifically, the initial state of the recurrent hidden vector, i.e. the state of the recurrent hidden vector before the recurrent neural network has processed any inputs in the current session, may be estimated based on the side input. FIG. 6 depicts an artificial neural network 600 in accordance with this embodiment of the invention. While FIG. 6 is described below in the context of providing words as input to the artificial neural network 600, it will be appreciated that the foregoing discussion is applicable to any suitable unigram input, as described above.

The artificial neural network 600 is a recurrent neural network, as described above with respect to FIG. 3, and includes an input layer 604, hidden layer 606, and output layer 608, 610, which may provide word-based predictions 608 and/or class-based predictions 610. The network further includes recurrent hidden vector 612, which, at each time step, is provided to the hidden layer 606 along with the values of the input layer 604, and is subsequently updated based on the output values of the hidden layer. In this way, the values of the elements of the recurrent hidden vector 612 are updated based on the previous word that was input to the artificial neural network 600, and previously input words can be taken into account for subsequent word predictions.

As discussed above, the recurrent hidden vector 600 is only capable of maintaining a short term context of previously input words. Thus, the artificial neural network further comprises a side input 614 and a side input layer 616. At the first time step, before any input words are provided to the artificial neural network, the side input 614 is provided to the side input layer 616, and the side input layer 616 is multiplied with a first weight matrix and non-linearity, such as a transfer function or activation function, e.g. a softmax function, sigmoid function, tan h function or any other known non-linearity, and applied to the recurrent hidden vector 612. In this way, the values of recurrent hidden vector 612 is initialised based on the long-term context provided by the side input 614, increasing the accuracy of the predictions output by the artificial neural network 600.

The side input 614 may be implemented as a side input vector, such as the unigram count vector 406 described above, but the side input may have different dimensions to the recurrent hidden vector. In this situation, the weight matrix of the side input layer 616 may be used to convert the side input 612 to the appropriate size. For example, the side input 614 may be a vector with 160 elements, whereas the recurrent hidden vector may have 512 elements. In this case, the side input layer may include a 160×512 matrix that is used to convert the 160 element side input vector into a 512 element vector through matrix multiplication. The values of the resulting 512 element vector can then be applied to the recurrent hidden vector.

The side input layer 616 may be a dense layer in that most or all of the nodes of the side input layer 616 are connected to all of the nodes of the recurrent hidden vector.

The side input layer 616 is trained along with the rest of the artificial neural network using the back-propagation of errors and gradient descent methods discussed above and described in Neural Networks—A Systematic Introduction by Rojas.

As described above, the side input 614 may only be provided to the side input layer 616 at a first time step, at the start of a new session of generating predictions using the artificial neural network 600, before generating any word predictions. In this way, the initial predictions generated by the artificial neural network 600 benefit from the long-term context held in the side input 614 and are, therefore, more accurate. The side input 614 may also be provided to the input layer 604 of the artificial neural network at each subsequent time step along with the current input word, as described above with respect to FIGS. 4 and 5; however, since the recurrent hidden vector 612 maintains a short-term context, it is not necessary to include more than a single input word in the input provided to the input layer 604 of the artificial neural network 600.

As mentioned above, the side input may be a basic summary of everything a user has ever typed, which may be represented by a single, monolithic unigram count vector. Alternatively, or additionally, the side input may be temporally limited, e.g. limited to the current session, or some other time period (e.g. a number of years, months, weeks, days, hours, etc.). Consequently, the side input may also maintain additional information regarding the temporal relevance of the unigram count. For example, several distinct unigram count vectors may be maintained for each unit of time, e.g. one hour, one day, one week, etc. When it is desirable to use side input that relates to only one unit of time, only the most-recent unigram count vector is used. When it is desirable to use a side input that relates to multiple units of time, the appropriate number of most-recent unigram count vectors may be added together using simple vector addition to provide the side input, as long as the corresponding elements of each unigram count vector relate to the same unigram. When it is desirable to use a user's entire history as the side input, all of the stored unigram count vectors are added together to produce the side input. It may be desirable to limit the long-term context in time to prevent old, discarded typing habits from influencing the predictions of words, or to reflect changes in a user's circumstances and surroundings. It may also be desirable to ensure that the side-input only relates to context that is longer-term than any other short-term context maintained by the artificial neural network, for example by only using unigram count vectors that are older than one hour, one day etc., to ensure that short-term context doesn't influence output predictions twice.

It will be appreciated that where multiple unigram count vectors are used, it is not necessary that they all relate to uniform time periods. For example, individual unigram count vectors for different writing sessions, different applications, different recipients (where the text input is used in a message sent to recipient, e.g. SMS or email) or different sources may be maintained.

The side input may also comprise additional context data such as the context derived from the electronic device on which words are input, or the app in which words are input. For example, a side input vector may comprise additional elements indicative of the current application, a recipient of a message that is typed, time or day, location, or the words/unigrams of a current conversation that is being carried out on an application into which a message is typed, etc.

Where the side input includes sources and unigram counts beyond those directly input and processed by the artificial neural network, such as unigram counts derived from text retrieved from social media accounts, email accounts, documents, etc., the unigram count from each of these sources may be stored as individual unigram count vectors that can be selectively added together to produce a desired side input, or may be bundled together with the other unigram counts into a single monolithic unigram count vector.

Thus, in view of the above discussion, it will be appreciated that the electronic device on which the artificial neural network operates may maintain a single, monolithic unigram count vector that relates to all unigram count vectors for all desired time periods, sources, sessions, etc. Alternatively, or additionally, the electronic device may maintain multiple unigram count vectors for one or more of different time periods, different sessions, different applications, different sources and different message recipients, that can be selectively combined by simple vector addition to provide the side input that is provided as an input to the artificial neural network or used to initialise the recurrent neural network.

In one embodiment, the one or more unigram count vectors which comprise the side input are continuously updated while the user inputs words and every written unigram is counted and added to the unigram count vector to be used as the side input. In this context the term “written unigram” may include unigrams that have been directly input to the system by a user as well as unigram predictions that have been output by the artificial neural network and selected for insertion into a text field by a user.

Alternatively, the side input may be updated on a discrete basis, for example once per hour, or once per day. If individual unigram count vectors are maintained for each unit of time, only the most-recent complete unigram count vectors may be used in the side input, while the unigram count vector that relates to the current time period is continuously updated, but is not used as part of the side input to the artificial neural network. If a monolithic unigram count vector is used, the monolithic unigram count vector may only be updated once per unit of time, e.g. once per hour, once per day, according to a separate unigram count that is not part of the side input until it is incorporated into the monolithic unigram count vector.

The one or more unigram count vectors may be normalised to prevent the side input outweighing the current input word provided as an input to the artificial neural network and the short term context—provided either by additional inputs or by a recurrent hidden vector—for example by using the L2 norm.

Furthermore, it will be appreciated that the side input need not be limited to unigram count vectors, but may also include frequency counts for groups or classes of unigrams. When the less frequently used unigrams are grouped or classified together, the computational complexity and memory requirements are reduced while still providing good resolution for the more frequently used unigrams.

The artificial neural network is typically located on an electronic device, for example a smartphone or tablet computer. The electronic device comprises at least one input interface, for example a touch sensitive display or a hard or soft keyboard, a processor, and the artificial neural network. Input to the artificial neural network is provided via the input interface, and the output predictions of the artificial neural network may be output on a graphical user interface of the electronic device.

The processor of the electronic device is configured to process the input received at the input interface with the artificial neural network to produce the one or more predicted next items in the sequence. The artificial neural network is preferably stored as computer-readable instructions in a memory associated with the electronic device, where the instructions can be accessed and executed by the processor.

Preferably, the input interface is a soft keyboard that operates on a touch-sensitive display of a mobile phone or tablet computer. The user of the electronic device first inputs a word to a text field using the soft keyboard, then enters a space character or punctuation. The space character or punctuation indicates to the keyboard software that the user has completed inputting the word. As an alternative to a space character or punctuation, the end of a word may be indicated by selection of a suggested correction or word completion. The keyboard software then utilises the artificial neural network to generate multiple predictions for the next word based on the input word. A pre-defined number, for example three or four, of most-likely predictions output by the artificial neural network (i.e. the words corresponding to the units of the output layer with the highest values) are then displayed on the touch-sensitive display, preferably concurrently with the keyboard, and preferably before the user begins to input the next word. The user may then select one of the displayed word predictions, prompting the keyboard to input the selected word into the text field. Once a word has been selected by a user, the selected word is then input to the artificial neural network and further predicted words are generated and displayed. Alternatively, if none of the word predictions presented to the user were correct, the user may continue to input the next word using the keys of the soft keyboard. As mentioned above, the selected word may also be added to the unigram count vector in order to update the side input.

If none of the displayed predictions are selected by the user of the electronic device, and instead the user proceeds to input the next word manually, the predictions for the current word that were generated by the artificial neural network are filtered by a filtering module according to the characters or other symbols that are input, and the displayed predictions may be updated according to the words with the highest probability that match that filter, using techniques that are known in the art. For example, taking the sentence discussed above with respect to FIG. 4, it is possible that the artificial neural network will not correctly predict that “school” is the most likely or one of the most likely next words given the input sequence items. In such a scenario, the word “school” would not be presented to the user such that they could select it as the correct prediction. If the correct prediction is not presented to the user, the user may begin to type the next word, i.e. “school”, into the electronic device. As the user types the letters of the word, the list of predictions generated by artificial neural network is filtered. For example, as the user types the letter “s” of “school”, the list of predictions is filtered to include only words beginning with the letter “s”. As the list of predictions is filtered, the predictions that are presented to the user may be updated, with predictions that do not match the filter being replaced by the next-most-likely predictions which do match the filter.

It will be appreciated that the filtering of predictions may be based on other factors than the characters that are typed. For example, if the user begins typing, implying that none of the displayed predictions are appropriate, the filter may simply discount the displayed predictions and the next-most-likely predictions may be displayed instead without taking into account which specific characters were typed. Alternatively, the filter may take into account that key presses can be inaccurate, and may expand the filter to include characters that are adjacent to or close to the typed character on the keyboard.

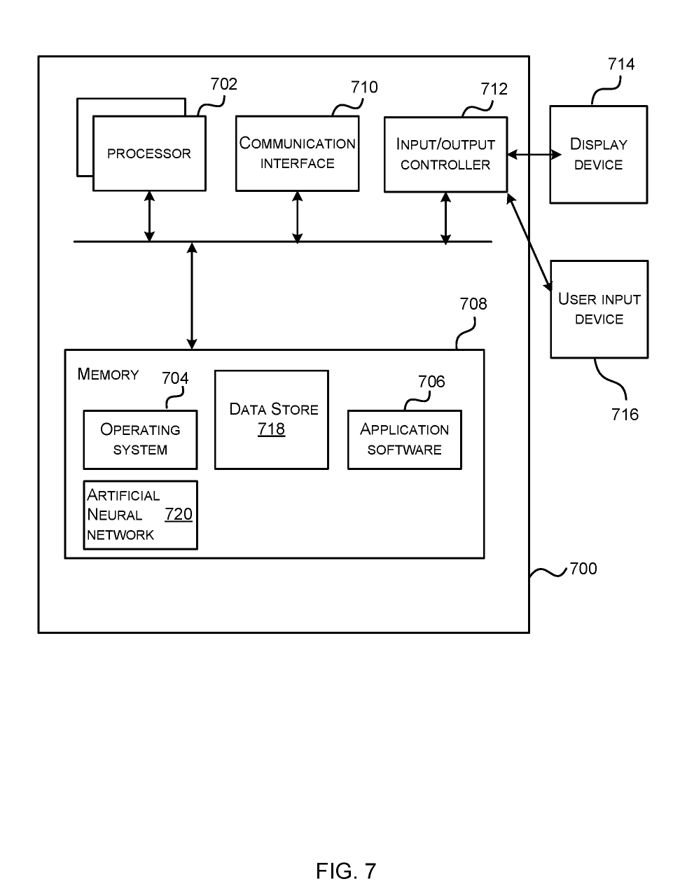

FIG. 7 is a schematic diagram of an electronic device, such as a smartphone, tablet computer, wearable computer, head-worn augmented reality computing device, or other computing-based device, having an artificial neural network as described herein.

Computing-based device 700 comprises one or more processors 702 which are microprocessors, controllers or any other suitable type of processors for processing computer executable instructions to control the operation of the device in order to process input received at an input interface with an artificial neural network to produce one or more predicted next items. In some examples, for example where a system on a chip architecture is used, the processors 702 include one or more fixed function blocks (also referred to as accelerators) which implement a part of the method of processing input received at an input interface with an artificial neural network to produce one or more predicted next items in hardware (rather than software or firmware). Platform software comprising an operating system 704 or any other suitable platform software is provided at the computing-based device to enable application software 706 to be executed on the device. A data store 718 holds sequences of items such as words, phrases, characters, emoji, which have been input by a user, and it holds predicted items, and optionally neural network parameter values. An artificial neural network 720 is stored at memory 708 and comprises at least a plurality of weights as well as a topology of the neural network and details of any activation functions used.

The computer executable instructions are provided using any computer-readable media that is accessible by computing based device 700. Computer-readable media includes, for example, computer storage media such as memory 708 and communications media. Computer storage media, such as memory 708, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 708) is shown within the computing-based device 700 it will be appreciated that the storage is, in some examples, distributed or located remotely and accessed via a network or other communication link (e.g. using communication interface 710).

The computing-based device 700 also comprises an input/output controller 712 arranged to output display information to a display device 714 which may be separate from or integral to the computing-based device 700. The display information may provide a graphical user interface. The input/output controller 712 is also arranged to receive and process input from one or more devices, such as a user input device 716 (e.g. a mouse, keyboard, camera, microphone or other sensor). In some examples the user input device 716 detects voice input, user gestures or other user actions and provides a natural user interface (NUI). This user input may be used to input words, characters, phrases, text or other input. In an embodiment the display device 714 also acts as the user input device 716 if it is a touch sensitive display device. The input/output controller 712 outputs data to devices other than the display device in some examples, e.g. a locally connected printing device.

Any of the input/output controller 712, display device 714 and the user input device 716 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

In an example there is a computer-implemented method comprising:

receiving one or more input sequence items using at least one input interface;

implementing, at a processor, an artificial neural network;

estimating an initial state of the artificial neural network based on a side input, wherein the side input is configured to maintain a record of input sequence items received at the input interface; and

generating one or more predicted next items in a sequence of items using the artificial neural network by providing an input sequence item received at the at least one input interface as input to the artificial neural network.

It will be appreciated that this description is by way of example only; alterations and modifications may be made to the described embodiments without departing from the scope of the invention as defined in the claims.

What is claimed is:

1. An electronic device comprising:
a processor, and
at least one input interface configured to receive one or more input sequence items;
wherein the processor is configured to:
implement an artificial neural network; and
generate one or more predicted next items in a sequence of items using the artificial neural network by providing an input sequence item received at the at least one input interface and a side input as inputs to the artificial neural network, wherein the side input is configured to maintain a record of input sequence items received at the input interface.

2. The electronic device of claim 1, wherein the processor is configured to generate the one or more predicted next items in the sequence of items by providing the input sequence item and the side input as inputs to an input layer of the artificial neural network.

3. The electronic device of claim 2, wherein the processor is configured to generate one or more subsequent predicted items in the sequence.

4. The electronic device of claim 3, wherein the processor is configured to generate the one or more subsequent predicted items in the sequence by providing a second input sequence item and the side input as inputs to an input layer of the artificial neural network.

5. The electronic device of claim 4, wherein the second input sequence item is the previously predicted next item in the sequence output by the artificial neural network.

6. The electronic device of claim 1, wherein the artificial neural network is a fixed context neural network.

7. The electronic device of claim 1, wherein the processor is configured to generate the one or more predicted next items in a sequence of items by further providing one or more additional input sequence items as input to the artificial neural network.

8. The electronic device of claim 7, wherein the input sequence item and one or more additional sequence items are consecutive previous sequence items.

9. The electronic device of claim 1, wherein the input sequence items and the side input are concatenated to form an input vector that is provided to an input layer of the artificial neural network.

10. The electronic device of claim 1, wherein the artificial neural network is a recurrent neural network.

11. The electronic device of claim 10, wherein the processor is configured to generate one or more predicted next items in the sequence of items by:
processing the side input with the artificial neural network by providing the side input to an input layer of the artificial neural network to initialise the artificial neural network; and
processing the input sequence item with the artificial neural network by providing the input sequence item to the input layer of the artificial neural network to generate the one or predicted next items in the sequence of items.

12. The electronic device of claim 10, wherein the processor is configured to generate one or more subsequent predicted items in the sequence.

13. The electronic device of claim 12, wherein the processor is configured to generate the one or more subsequent predicted items in the sequence by providing a second input sequence item as an input to an input layer of the artificial neural network.

14. The electronic device of claim 13, wherein the second input sequence item is the previously predicted next item in the sequence output by the artificial neural network.

15. An electronic device comprising:
a processor, and
at least one input interface configured to receive one or more input sequence items;
wherein the processor is configured to:
implement an artificial neural network;
estimate an initial state of the artificial neural network based on a side input, wherein the side input is configured to maintain a record of input sequence items received at the input interface; and
generate one or more predicted next items in a sequence of items using the artificial neural network by providing an input sequence item received at the at least one input interface as input to the artificial neural network.

16. The electronic device of claim 15, wherein the artificial neural network is a recurrent neural network.

17. The electronic device of claim 16, wherein the processor estimates an initial state of the artificial neural network by estimating values for a recurrent hidden vector of the recurrent neural network.

18. The electronic device of claim 17, wherein the artificial neural network further comprises a side input layer.

19. The electronic device of claim 18, wherein the processor is configured to estimate the initial state of the artificial neural network based on a side input by providing the side input to the side input layer.

20. A computer-implemented method comprising:
receiving one or more input sequence items using at least one input interface;
implementing, at a processor, an artificial neural network;
estimating an initial state of the artificial neural network based on a side input, wherein the side input is configured to maintain a record of input sequence items received at the input interface; and
generating one or more predicted next items in a sequence of items using the artificial neural network by providing an input sequence item received at the at least one input interface as input to the artificial neural network.
